(19) United States
(12) Patent Application Publication
(10) Pub. No.: US 2010/0205229 A1
(43) Pub. Date: Aug. 12, 2010

(54) SYSTEM AND METHOD FOR INSTANCES REGISTERING BASED ON HISTORY

(75) Inventors: Han Min Jung, Daejeon (KR); In-Su Kang, Daejeon (KR); Pyung Kim, Daejeon (KR); Mi Kyung Lee, Gyeongsan (KR); Seung-Woo Lee, Daejeon (KR); Won Kyung Sung, Daejeon (KR); Dong In Park, Seoul (KR); Sun Hwa Hahn, Daejeon (KR)

Correspondence Address: LRK Patent Law Firm, 1952 Gallows Rd, Suite 200, Vienna, VA, 22182, US

(73) Assignee: KOREA INSTITUTE OF SCIENCE AND TECHNOLOGY INFORMATION, Daejeon (KR)

(21) Appl. No.: 12/676,380

(22) PCT Filed: Sep. 4, 2008
(86) PCT No.: PCT/KR08/05215

§ 371 Date: Mar. 4, 2010

(30) Foreign Application Priority Data
Sep. 5, 2007 (KR) 10-2007-0090100

(51) Int. Cl. G06F 17/30

(52) U.S. Cl. 707/805; 707/E17.005

(57) ABSTRACT

A system for registering instances based on history is disclosed. An instance registration setting unit reads ontologies and storing them in memory, and provides an interface capable of editing one or more instances included in each of classes. The instances are provided through an ontology viewer for visualizing relationships between the stored ontologies. An instance registration editing unit edits, searches for, and registers the instances using the interface provided by the instance registration setting unit, and supports the editing by extracting one or more object names based on external information while managing the edited instances based on the history.

### TECHNICAL FIELD

The present invention relates, in general, to a system and method for registering instances based on history, and, more particularly, to a system and method for registering instances based on history which enables instances to be easily edited and registered with regard to a plurality of ontologies connected to one another while having interrelationships therebetween.

### BACKGROUND ART

Recently, a model of processing the data of a database, to which an ontology is applied, has been the focus of attention.

An ontology is a data processing method or model for representing a specific region of a database, and a set of formal vocabularies which describes concepts within a specific domain and the relationship between those concepts.

For example, the relationship between creatures which are divided into Species, Genus, Family, Order, Class, Phylum and Kingdom, or the relationship between English words can be described using formal vocabularies. The relationship, described using the formal vocabularies, is referred to as an “ontology”.

Here, an ontology, which is a set of vocabularies described using a formal language, has been used for reasoning (inferring), and recently has been mainly utilized in the fields of machine translation of natural language and artificial intelligence.

Recently, ontologies have been the focus of attention as the important element of semantic Webs which use an ontology for describing the relationship between specific fields of Internet sources, and of semantic Web services derived from such a semantic Web.

A general method of registering instances using an ontology is realized in such a way that a specific concept of class (for example, a person or an institution) is selected from an ontology schema, and information for one or more instances is input for the selected class.

That is, an independent single instance, for example, an instance which can be represented by a person who has an identifier XXX or an institution which is located in ‘Daejeon’ and has an identifier YYY, is generated through a single process of editing using an ontology.

However, an ontology schema has become complicated in recent semantic Webs, and has changed in the direction in which management is realized based upon Universal Resource Identifiers (URIs) rather than instance character strings. Herein, the instance is a separate object element which is included in a specific set in a database.

In order to complete a single instance based on the schema of ontologies associated with one another, a system for registering instances, the editing process of which is terminated, has a problem in that it is difficult to improve the efficiency of generally connecting the instances.

A schema is a data structure for a database, and the schema corresponds to a logical structure when viewed from a user or corresponds to a physical structure when viewed from a computer.

As the number of instances increases to millions or tens of millions or more, it is difficult to define interrelationship between the instances and to relate them with each other.

For these reasons, when information for instances to be input to a class, selected based on an ontology schema, is input and edited, a technology has been required for enabling instances associated with one another to be simultaneously edited during the generation of a specific instance, rather than editing a single separate instance.

### DISCLOSURE

### Technical Problem

Accordingly, the present invention has been made keeping in mind the above problems occurring in the prior art, and an object of the present invention is to provide a system and method for registering instances based on history which continuously edits and registers instances based on history through ontologies having interrelationships therebetween, so that instances associated with one another can be efficiently edited and registered while a consistent flow of editing is maintained.

### Technical Solution

In order to accomplish the above object, the present invention provides a system for registering instances based on history, including an instance registration setting unit for reading ontologies and storing them in memory, and providing an interface capable of editing one or more instances included in each of classes, which are provided through an ontology viewer for visualizing relationships between the stored ontologies; and an instance registration editing unit for editing, searching for, and registering the instances using the interface provided by the instance registration setting unit, and supporting the editing by extracting one or more object names based on external information while managing the edited instances based on the history.

The instance registration setting unit includes an ontology storage unit, an ontology view provision unit, and an instance editing User Interface (UI) provision unit. The ontology storage unit reads the ontologies and determines consistency thereof, and then stores an ontology which has a problem of the consistency in the memory in a file form.

Further, the ontology view provision unit enables the ontology classes to be visually displayed in various forms through the viewer, and, if a specific class is selected on the viewer, lists and outputs one or more instances of the selected class.

The instance editing UI provision unit provides an interface for displaying various types of editing ranges which can be used to edit an ontology selected by the ontology view provision unit, and enabling the editing of the editing ranges.

The instance registration editing unit includes an instance editing unit, an instance searching unit, an instance registration unit, a history management unit, an external information provision unit, and an object name extraction unit. One or more instances are edited using an interface provided through the instance editing UI provision unit, and instances found during the process of editing are stored in a sever or a separate database.

Here, if an instance is required to be additionally registered during the process of editing instances, an instance on which a task is currently performed is stored in the memory in a file form, and a task for a new instance is performed, so that history is managed and one or more object names extracted by the object name extraction unit is provided to the instance editing unit.

Further, another object of the present invention is accomplished by providing a method of registering instances based on history, including the steps of reading ontologies and storing them in memory; visually displaying the classes of at least one stored ontology, and outputting one or more instances of a selected class;

providing an interface for the editing ranges of the selected class of the ontology; editing the instances using an interface provided by an instance editing UI provision unit, searching for one or more relevant instances, inserting the found instances into an instance editing unit, and registering them in a server or a database; and naming one or more object names extracted based on external information while managing edited history.

Here, the step of editing and registering the instances includes the step of previously checking the consistency of instances to be registered and providing final notification of whether the instances are registered based on results stored in registration storage to a user.

### ADVANTAGEOUS EFFECTS

The method of registering instances based on history according to the present invention continuously edits and registers instances based on history through ontologies having interrelationships therebetween, so that instances associated with one another can have a consistent flow of editing, and thus the present invention has an advantage of improving the efficiency of editing and registering instances.

### DESCRIPTION OF DRAWINGS

FIG. 1 is a block diagram showing a system for registering instances based on history according to the present invention;

FIG. 2 is a screen diagram showing the configuration of the editing interface of the system for registering instances based on history according to the present invention;

FIG. 3 is a diagram showing an example of an ontology for a treatise in the system for registering instances based on history according to the present invention; and

FIG. 4 is a diagram showing the flow of editing in the system for registering instances based on history according to the present invention.

### BEST MODE

The technical configuration and operational effect for the object of a system and method for registering instances based on history according to the present invention will be clearly understood through the following descriptions below with reference to the attached drawings which show embodiments.

It should be noted that, in the following description, when it is determined that the detailed descriptions of well-known techniques or configurations related to the present invention would obscure the gist of the present invention, they are omitted. Terms which will be described herein are defined by considering the functions thereof in the context of the present invention, and may vary depending on the intention of a user or an operator. Therefore, the meanings of the respective terms must be interpreted based on the details described in the general description of the present invention.

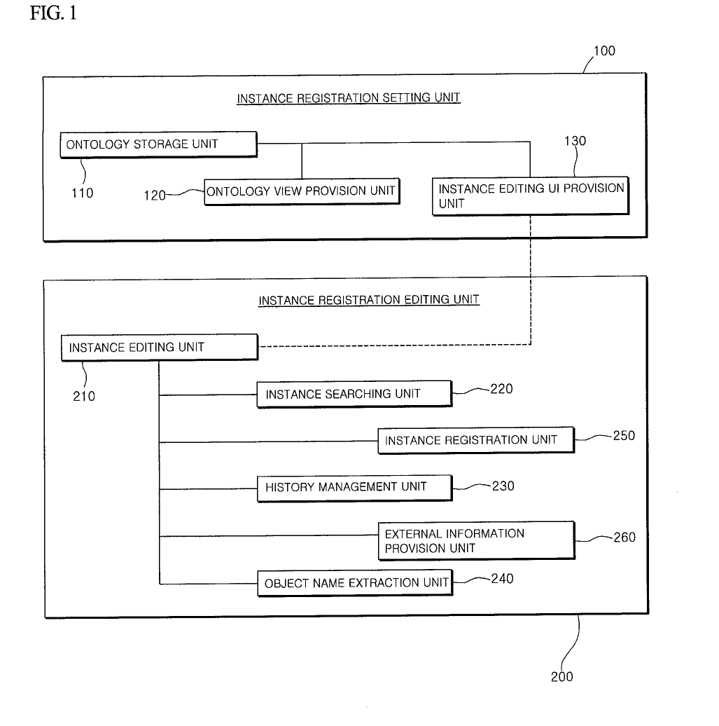

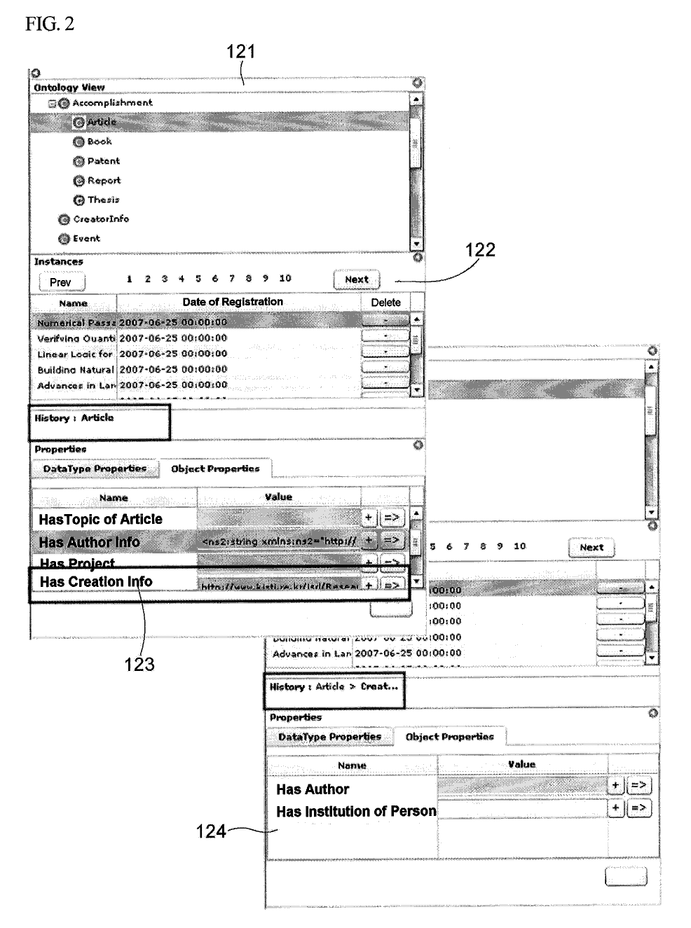

First, FIG. 1 is a block diagram showing a system for registering instances based on history according to the present invention. FIG. 2 is a screen diagram showing the configuration of the editing interface of the system for registering instances based on history according to the present invention.

As shown in the drawings, the system for registering instances based on history according to the present invention is configured to mainly include an instance registration setting unit 100 for outputting an ontology and providing an editing interface, and an instance registration editing unit 200 for editing, searching for, and registering one or more instances using the provided interface.

The instance registration setting unit 100 is configured to include an ontology storage unit 110 for reading and storing an ontology, an ontology view provision unit 120 for outputting the stored ontology, and an instance editing User Interface (UI) provision unit 130 for providing an editing interface for instances included in each class of the ontology.

Here, the ontology storage unit 110 reads an ontology written in an ontological language including an Ontology Web Language (OWL), checks whether the ontology has a problem for consistency using, for example, an OWL parser, and then loads or stores the ontology in memory if there is no problems of consistency.

Further, the ontology view provision unit 120 includes a display unit for outputting an ontology schema, and lists and outputs each of the classes of the ontology schema.

As shown in the screen diagram of FIG. 2, if one of the listed classes is selected using an ontology view 121 located in upper left portion of the screen, instances which constitute the corresponding ontology are sequentially arranged on the instance view 122 located at the lower portion of the ontology view 121.

Further, the ontology selected on the ontology view 121 may be edited using the instance registration editing unit 200 based on one or more requirements given to a specific instance to be applied to the corresponding class, and an interface for editing the instance is provided through the instance editing UI provision unit 130.

With regard to the interface provided by the instance editing UI provision unit 130, various types of interfaces are provided through the user interface view 123 located at the lowermost left portion of the screen of the screen diagram of FIG. 2, that is, interfaces configured to show an editing range, including properties, resources and character strings which can be used to edit a specific instance (domain), and to enable the editing range to be edited are provided.

Further, if the editing range whose edited content is not filled exists in the editing range of the user interface view 123 arranged at the left portion of the screen, the corresponding editing range is selected and then a user interface view 124 is output on the lower right portion of the screen. The output user interface view 124 also shows editing ranges, including, properties, resources and character strings which can be used to edit a specific instance, like on the left portion of the screen, and provides an interface which enables the editing range to be edited.

Meanwhile, the instance registration editing unit 200 edits, searches, registers, and manages instances using the user interface provided through the instance registration setting unit 100, so that edited instances are managed based on history and object names are extracted based on external information, thereby supplying the editing of the instances.

The instance registration editing unit 200 includes an instance editing unit 210, an instance searching unit 220, an instance registration unit 230, a history management unit 240, an external information provision unit 250, and an object name extraction unit 260.

The instance editing unit 210 edits instances using the user interface provided by the instance registration setting unit 100, and the editing method thereof may be realized using various methods, for example, a method of newly generating instances in such a way that an operator directly inputs character strings and a method of using one or more instances found from existing instances.

Further, the instance searching unit 220 searches for previously registered instances during a process of editing instances by the instance editing unit 210, and the instances to be searched for correspond to one or more instances included in a class corresponding to the relevant editing range defined by the ontology.

The instance searching unit 220 is configured to request that a URI server search for an instance using a Structured Query Language (SQL) or a search engine, and to include a searching interface for outputting the results of searching on part of the screen of the screen diagram of FIG. 2.

Here, if the operator selects any one of the found instances from among the results of searching output on the searching interface of the instance searching unit 220, the selected instance is inserted into the instance editing unit 210.

Further, the instance registration unit 230 receives a registration request made by the instance editing unit 210, and registers edited instances or the character strings in the URI server or a Database Management System (DBMS).

Here, the instance editing unit 220 or the instance registration unit 230 previously checks consistency for the edited instances or instances to be registered, receives results stored in registration storage, and then provides final notification of whether the instances have registered to the operator.

The history management unit 240 manages plurality of edited instances based on history, and, if one or more additional instances corresponding to the relevant editing range are required to be newly registered during the process of editing instances using the instance editing unit 210, edits the instances to be newly registered.

For example, in the case in which instances for information about a specific person included in class ‘person’ is being edited and information about an institution does not exist, one or more instances for the institution must be first generated anew. Content on which a task is currently performed is stored in memory or in the form of a file, and then the instances for the institution to be newly registered are edited.

Thereafter, when the instances to be newly registered have been edited and registered, the instances, in which information about the institution has been registered, is automatically added to the relevant editing range within the instance which was being previously edited.

Therefore, since the instances are supplementarily edited by the history management unit 240, the operator can omit a process of separately searching for one or more instances related to a relevant instance using object properties, unlike the prior art.

With regard to the instances edited and registered using the instance editing unit 210, the instance registration unit 230 and the history management unit 240, object names are given to the corresponding instances by extracting the object names based on external information, and the object names extracted based on the external information are provided to the instance editing unit 210.

The external information for the extraction of the object names is provided through the external information provision unit 250, and the external information, such as a web page or another type of file, can be displayed on a screen through a web browser, besides by the instance view provision unit 120 of the instance registration setting unit 100.

The external information provided through the external information provision unit 250, is extracted in the form of one or more object names using an object name extractor which is driven by the object name extraction unit 260, and the object names extracted by the object name extraction unit 260 are provided to the instance editing unit 210 by such editing methods as ‘drag and drop’ and ‘copy and paste’. Here, the object names extracted based on the external information may be converted or normalized based on the reference of the operator such that the types thereof are standardized, thereby improving the efficiency of editing.

With regard to the configuration of a screen for the system for registering instances according to the present invention with reference to FIG. 2, an editing history variation process for registering instances is output through the left and right portions of the screen, as shown in FIG. 2.

When class ‘Article’ is selected from an ontology schema listed through the ontology view 121 shown in the left portion of the screen, a plurality of instances is sequentially arranged through the instance view 122 which is located in the lower portion of the ontology view 121.

Here, if a relevant instance is selected in a process of editing the specific instance of the class ‘Article’, output on the instance view 122, a plurality of object properties is output on the user interface view 123 which is located in the lower portion of the instance view 122.

Further, if one object property is selected from among a plurality of object properties, including a relationship name, on the user interface view 123, movement is performed to another user interface view 124 which is located in the right portion of the screen, and thus an instance corresponding to an editing range included in the object property, having selected relationship name ‘hasCreationInfo’, can be edited.

Here, history for the relationship name of the corresponding instance changes from ‘Article’ to ‘Article>hasCreationInfo’, and ‘Article’ which was being previously edited is stored in the memory or a file through the history management unit 240. After ‘hasCreationInfo’ is edited, the corresponding instance is provided to the instance editing unit 210 and then automatically included in the editing range of ‘Article’.

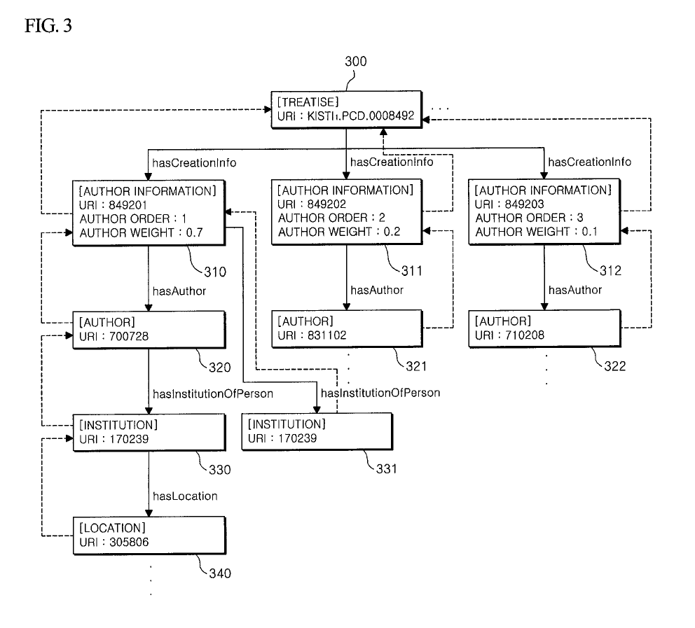

Next, FIG. 3 is a diagram showing an example of an ontology for a treatise in the system for registering instances based on history according to the present invention.

As shown in the drawing, a single treatise class 300 includes a number of author information classes 310 to 312 which correspond to the number of the authors described in the treatise. Each of the author information classes 310 to 312 may include one or more author classes 320 to 322 and one or more institution classes 330 and 331 to which one or more relevant authors belonged when they wrote the treatise.

Further, when each of the author classes 320 to 322 includes one or more institution classes 330 and 331, each of the institution classes 330 and 331 may have the location class 340 thereof.

According to information about the instances of an ontology schema shown in FIG. 3, the treatise instance, named based on the URI of KISTI1.PCD.0008492, includes three author information instances. The author information instances are respectively named ‘849201’, ‘849202’, and ‘849203’ in the order of the authors of the treatise.

Here, the treatise class 300 is connected to the author information classes 310 to 312 using the relationship name of ‘hasCreationInfo’.

Here, ‘849201’, which corresponds to the instance information of the first author information class 310, is author information whose author order is indicated as being the first and it has a weight of 0.7. The author information class 310 includes an author instance named 700728, an institution instance named 170239, and a location instance named 305806.

Here, the author information class 310, having the instance 849201, may be connected to the institution class 331 named according to another institution instance, as well as the institution instance 170239 included in the author instance named 700728.

Since the instance information of the institution class 330 of the author class 320 is the same as the instance information of the institution class 331 of the author information class 310, that is, the instance information named 170239 based on an URI, it can be known that the institution, to which the first author of the treatise currently belongs, is the same as the institution to which the first author belonged when the treatise was authored.

For reference, the institution classes 330 and 331 are connected to the location class 340, having the instance information named 305806, using the relationship named ‘hasLocation’.

The author information classes 310 to 312, connected from the treatise class 300, the author classes 320 to 322, the institution classes 330 and 331, and the location class 340 are connected using relationship names, such as ‘hasCreationInfo’, ‘hasAuthor’, ‘hasInstitutionOfPerson’, and ‘haslocation’, each of which is capable of having an editing range corresponding to object properties for the connection to lower instance information between the classes.

Since the OWL, which is an ontology language basically applied to the present invention, has an expression method corresponding to a Resource Description Framework (RDF) triple, a concept system which is not directly expressed using the triple should connect various types of information using a plurality of middle classes such as the author information class 310 of the treatise class 300.

In this case, the system for registering instances based on history according to the present invention may be applied.

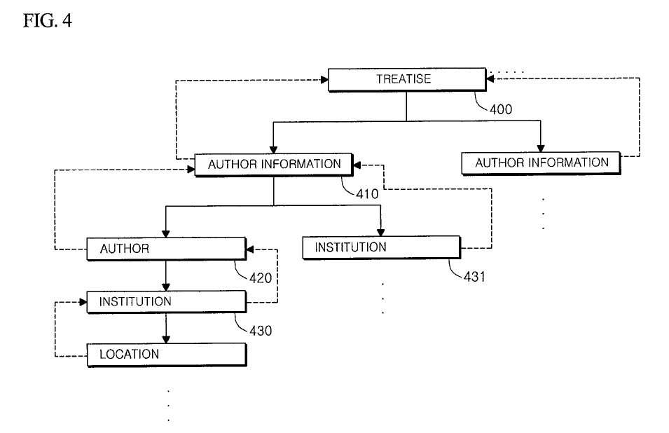

At last, FIG. 4 is a diagram showing the flow of editing in the system for registering instances based on history according to the present invention.

With reference to the configuration of the ontology for a treatise shown in FIG. 3, history for a process of editing instances is managed and maintained while depth-first search is performed based on the ontology of a treatise, as shown in the drawing.

In FIG. 4, solid lines indicate proceeding directions for a process of registering instances based on history, and dotted lines indicate movement directions into each previous step after one or more corresponding instances have been edited and registered in the class of the ontology.

In greater detail, with regard to the treatise instance 400, an editing process moves to each of author information instances 410, included in the treatise, using the above-described instance registration editing unit 200. When the editing process moves from one of the author information instances 410 to an author instance 420, if an author instance already exists, the author instance 420 is searched for and then registered through the instance searching unit 220 of the instance registration editing unit 300. Thereafter, the editing process returns to the higher author information instance 410, and then the editing process for the corresponding instance is performed.

If the relevant author instance 420 does not exist and the author instance must be newly generated, the editing process moves to an institution instance 431 for the corresponding author information.

Here, in the case in which the institution instance 431 to which the editing process moved from the author information instance 410 is different from the institution instance 430 which is associated with the author instance 420, the institution instance 430 which was being edited is stored in memory or in the form of a file, an author instance 420 for the relevant author information is newly prepared, and then an institution instance connected to the author instance 420 is prepared.

If the above-described processes are repeated, the above-described treatise instance is edited and registered.

A method of registering instances for the system for registering instances based on history according to the present invention will be described in brief below.

First, if a history-based ontology schema is prepared, an ontology is read and stored in memory using the ontology storage unit 110. One or more ontology classes, including the stored ontology, are visually displayed in tree or graph form, and the instance information of a selected class is output using the ontology view 121.

Thereafter, an interface for the editing range of the ontology, which is output and selected using the ontology view 121, is provided to the instance registration editing unit 200 through the instance editing UI provision unit 130, and the instance editing unit 210 of the instance registration editing unit 200 edits the information of the relevant instance using a provided user interface.

Thereafter, an instance associated with the editing range of a relevant instance can be searched for during a process for editing instances using the instance editing unit 210. When a new instance is required to be registered in addition to the found instance associated with the editing range, the new instance is edited after the instance which was being prepared is stored. The new instance is inserted into the instance editing unit 210 and then registered in a server or a database.

At last, the instance edited using the instance editing unit 210 and the instance searching unit 220 is managed through the history management unit 240, and an object name extracted by the object name extractor based on the external information, such as a Web page or another file, is given.

Here, when instances are edited or registered, the consistency of instances to be registered can be previously checked, and then notification of whether the instances are finally registered can be provided to the operator based on results stored in registration storage.

Further, in the case in which the instance to be newly registered has edited and registered, the instance information, which has been registered in the corresponding editing range of the instance which was being previously edited, is automatically provided to the instance editing unit 210 through the history management unit 240, thereby omitting a process of separately searching for an instance which will be connected based on the object property when the instance is being edited.

The preferred embodiments of the present invention have been disclosed for illustrative purposes. Those skilled in the art should appreciate that various substitutions, modifications, variations are possible without departing from the technical spirit of the invention, and the substitutions and variations are disclosed in the accompanying claims.

### INDUSTRIAL APPLICABILITY

The present invention relates to a system and method for registering instances based on history which edits and registers the instances based on continuous history with regard to ontologies having interrelationships therebetween, so that the instances associated with one another can have a consistent flow of editing, thereby improving the efficiency of the editing and registration of the instances.

1. A system for registering instances based on history, comprising:
an instance registration setting unit for reading ontologies and storing them in memory, and providing an interface capable of editing one or more instances included in each of classes, which are provided through an ontology viewer for visualizing relationships between the stored ontologies; and
an instance registration editing unit for editing, searching for, and registering the instances using the interface provided by the instance registration setting unit, and supporting the editing by extracting one or more object names based on external information while managing the edited instances based on the history.

2. The system according to claim 1, wherein the instance registration setting unit comprises an ontology storage unit, an ontology view provision unit, and an instance editing User Interface (UI) provision unit.

3. The system according to claim 2, wherein the ontology storage unit reads the ontologies and determines consistency thereof, and then stores an ontology which has a problem of the consistency in the memory in a file form.

4. The system according to claim 2, wherein the ontology view provision unit enables the ontology classes to be displayed in various forms through the viewer, and, if a specific class is selected on the viewer, lists and outputs one or more instances of the selected class.

5. The system according to claim 4, wherein the ontology view provision unit lists and outputs each of the classes of an ontology schema.

6. The system according to claim 2, wherein the instance editing UI provision unit provides an interface for displaying various types of editing ranges which can be used to edit an ontology selected by the ontology view provision unit, and enabling editing of the editing ranges.

7. The system according to claim 6, wherein each of the editing ranges comprises any one of an object property, a resource and a character string which can be used to edit a specific instance (domain).

8. The system according to claim 1, wherein the instance registration editing unit comprises:
an instance editing unit for editing the instances using a user interface provided by the instance registration setting unit;
an instance searching unit for searching for one or more instances which have been previously registered during a process of editing instances using the instance editing unit;
an instance registration unit for registering the instances or character strings, edited in response to a registration request made by the instance editing unit, in a Uniform Resource Identifier (URI) server or a Database Management System (DBMS);
a history management unit for managing the plurality of edited instances based on history;
an external information provision unit for providing information required when the instances are edited using the instance editing unit; and
an object name extraction unit for extracting one or more object names using an object name extractor based on the information provided by the external information provision unit.

9. The system according to claim 8, wherein the instance editing unit edits the instances using the user interface provided by the instance registration setting unit, and an editing method thereof comprises newly generating the instances in such a way that an operator directly inputs the character strings, or performing editing using one or more instances found from existing instances.

10. The system according to claim 8, wherein the instance searching unit searches for the instances which have been previously registered during the process of editing instances using the instance editing unit, and the instances to be searched for correspond to instances included in a class, which correspond to a relevant editing range defined in one of the ontologies.

11. The system according to claim 8, wherein, if an additional instance corresponding to an editing range is required to be newly registered during the process of editing instances using the instance editing unit, the history management unit stores an instance on which a task is currently performed in the memory in a file form, edits the instance to be newly registered, and, if the instance to be newly registered has edited and registered, automatically adds the instance, which has been registered, to a relevant editing range of the instance which was being previously edited.

12. A method of registering instances based on history, comprising the steps of:
reading ontologies and storing them in memory;
visually displaying classes of at least one stored ontology, and outputting one or more instances of a selected class;
providing an interface for editing ranges of the selected class of the ontology;
editing the instances using an interface provided by an instance editing UI provision unit, searching for one or more relevant instances, inserting the found instances into an instance editing unit, and registering them in a server or a database; and
naming one or more object names extracted based on external information while managing edited history.

13. The method according to claim 12, wherein the step of editing and registering the instances comprises the step of previously checking consistency of instances to be registered and providing final notification of whether the instances are registered based on results stored in registration storage to a user.

14. The method according to claim 12, wherein, if one or more instances to be newly registered have edited and registered, the step of editing and registering the instances comprises the step of a history management unit automatically providing information for one or more instances, which have been registered in a relevant editing range of an instance which was being previously edited, to the instance editing unit.
